(19) United States
(12) Patent Application Publication
(10) Pub. No.: US 2026/0020714 A1
(43) Pub. Date: Jan. 22, 2026

(54) BEVERAGE OR FOODSTUFF PREPARATION SYSTEM

(71) Applicant: SOCIÉTÉ DES PRODUITS NESTLÉ S.A., Vevey (CH)

(72) Inventors: André NOTH, Pully (CH); Didier VUAGNIAUX, Gimel (CH); Alexandre KOLLEP, Lutry (CH); Olivier PAILLARD, Metabief (FR)

(21) Appl. No.: 18/998,705

(22) PCT Filed: Jul. 31, 2023
(86) PCT No.: PCT/EP2023/071114

§ 371 Date: Jan. 27, 2025

(30) Foreign Application Priority Data
Jul. 29, 2022 (EP) 22187725.1

(51) Int. Cl. A47J 31/44; A47J 31/36; A47J 31/52; B65D 85/804; G06K 7/10; G06K 7/14

(52) U.S. Cl. CPC A47J 31/4492; A47J 31/369; A47J 31/525; B65D 85/8058; B65D 85/8064; G06K 7/1404; G06K 2007/10504

(57) ABSTRACT

A system (2) comprising a container (6) and a machine (4) for preparing a beverage and/or foodstuff thereof, the container (6) including: a body portion (62) comprising a storage portion (58) for containing a precursor material; a closing member (56) to close the storage portion (58), and; a machine-readable code (44) storing preparation information, the machine (4) including: a code reading system (18) to read the code (44) of the container (6); a processing unit (14) for processing the precursor material of the container (6), and: electrical circuitry (16) to control the processing unit (14) based on the preparation information read from the code (44), wherein the code reading system (18) includes a positioning mechanism (110) to apply a variable loading condition to the container (6), and the code reading system (18) includes a detection system (150) to detect a reading position if a predetermined condition for reading the code (44) is met, and if said condition is met, then the electrical circuitry (16) configured to process the code (44) to extract the preparation information in the reading position.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine to define a recipe, and; the recipe is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

EP 2594171 A1 discloses a machine that reads a code from an underside of a flange of a capsule. A drawback is that the code cannot be applied to parts of the capsule that are more flexible, e.g. the membrane, since the code can only be read from a rigid support. Moreover, for the same reason, the code cannot be applied to alternative capsules where a body of the capsule is made from different materials which are more flexible, e.g. recyclable materials, including paper or wood pulp.

Therefore, in spite of the effort already invested in the development of said systems further improvements are desirable.

### SUMMARY

The present disclosure provides a system comprising a container and a machine for preparing a beverage and/or foodstuff.

The container includes a body portion that has a storage portion for containing a precursor material and a closing member to close the storage portion, and; a machine-readable code storing preparation information. As used herein reference to a “code” may include one or more repetitions of the code. In embodiments, the code is arranged on a central region of the closing member. The storage portion includes a cavity that extends in a depth direction from the closing member. The container may have a maximum depth that is less than its diameter, which can be measured at the opening of the storage portion. In embodiments the code is an optically readable code.

In embodiments, the body portion includes a flange portion that connects the storage portion to the closing member. The cavity of the storage portion extends in a depth direction from the flange portion. The flange portion presents a generally planar peripheral rim for receiving the closing member. In embodiments, the flange portion is planar. As used herein the term “planar” in respect of the flange portion may refer to the flange portion arranged to extend entirely with the lateral and longitudinal directions, or substantially with said directions (e.g. with major components in these directions as opposed to a depth direction).

The machine includes a code reading system with a code reader to read the code of the container; a processing unit for processing the precursor material of the container, and; electrical circuitry to control the processing unit based on the preparation information read from the code. As used herein the term “based on” in respect of the preparation information may refer to a direct relationship (e.g. a value of a parameter of a recipe is encoded directly on the code) or a rule is used via a stored relationship to look up one or more of said values using the preparation information as an identifier. The code reader may include an image capturing unit (e.g. a camera) a lens and an outermost aperture (e.g. a reading window). An outermost portion of the code reader may be referred to as a reading head.

In embodiments, the machine includes a positioning mechanism which is configured to position the container in a holding position or a reading position in which the code can be read by the code reading system.

In embodiments, the positioning mechanism is adapted to deform the body portion of the container from an undeformed configuration to a deformed configuration, in which the code is readable by the code reader. In the undeformed position the code may not be readable, including reliably readable, by the code reader, e.g. due to wrinkling or other non-uniform shaping of the closing member.

In embodiments, the positioning mechanism adapted to deform the body portion in the deformed configuration to effect subsequent deformation of the closing member so that it presents a comparatively more uniform surface for reading the code. The deformation of the body portion may be by applying 3-point bending and/or a bending moment in a lateral direction to the body of the container. The deformation may be applied directly to the body portion and indirectly to the closing member, such that the positioning mechanism does not directly contact the closing member (which may exclude a portion of the closing member that overlaps the flange portion).

By implementing the position mechanism to deform the body portion to effect a specific deformation of the closing member to improve reading, the closing member may be manipulated without the positioning mechanism directly applying load to deform the closing member directly thereto. Such an implementation may be advantageous since damage to the closing member due to direct contact with the positioning mechanism may be avoided. Such an implementation may enable a range of materials to be implemented for the storage portion, e.g. materials that are flexible including paper or wood pulp compared to a comparatively rigid material such as aluminium.

As used herein the term “uniform” may refer to a comparatively more even spatial arrangement to the undeformed configuration, e.g., more planar and absent of, which may include the absence or reduction of folds, creases or other spatial discontinuities that would otherwise interfere with reading of the code.

In embodiments, in the deformed configuration the closing member is increased in tension compared to the undeformed configuration.

By implementing the positioning mechanism to deform the body portion of the container to increase tension (e.g. an in plane membrane tension as opposed to a through thickness tension) of the closing member, the code of the closing member may be more accurately read, since the closing member is presented more uniformly for reading.

As used herein the term “deform” in respect of the body portion may refer to deformation of the storage portion and/or flange portion that is elastic or plastic including fully or partially reversible.

As used herein the term “holding position” may refer to a position in which the container is held prior to being subject to loading, e.g. to cause its displacement and/or deformation into a reading position. In suitable embodiments, the container in the holding position is arranged in an undeformed configuration. In the holding position the code may not be readable by the code reader, e.g. the code may be positioned too far away from or otherwise unreadable by a code reader of the code reading system, e.g. due to winking of the code.

As used herein the term “reading position” may refer to a position in which load is applied to one or more portions of the container to deform the container to improve readability of the code on the container. In suitable embodiments, the container in the reading position is arranged in a deformed configuration. The reading position may be defined by a range of positions in which a loading criterion has been exceeded or a single condition in which a load condition is achieved. The reading position may be defined as a position in which the code reader (e.g. a reading head thereof) is in contact, including pressed into, the code and may be readable to extract the preparation information from the code.

In embodiments, in the deformed configuration, the flange portion is deformed to implement a change in curvature (e.g. in overall global curvature, rather that local curvature due to creases etc) along a lateral direction compared to the undeformed configuration. The curvature may be defined as the deviation from a straight line in the lateral direction (e.g. which the flange position generally assumes in the undeformed configuration) that bridges left and right sides of the container, when viewed from a plane defined by the longitudinal and depth directions.

By implementing the positioning mechanism to change curvature (e.g. to increase the curvature) across the flange portion, the path that the closing member extends may be increased or otherwise adjusted to conveniently provide tensioning for improved readability. A degree of curvature can be defined by a magnitude of the first order spatial derivative of the depth and lateral direction.

In embodiments, in the deformed configuration the central region of the closing member experiences less curvature than a peripheral region (e.g. at the left and right sides) of the closing member.

Less curvature (e.g. a turning point in the derivative of the depth and lateral direction) at the central region on the closing member where the code is read may improve readability.

In embodiments, the code is arranged on a central region of the closing member, and in the deformed configuration the central region of the closing member is displaced in the counter depth direction (e.g. relative the flange portion or its spatial position prior to deformation).

By implementing the central region of the closing member that comprises the code to be displaced forward, i.e. in the counter depth direction, a generally planar central region may be achieved, which is more reliable to read than when in the undeformed position.

As used herein the term “central region” refers to a region of the closing member that includes at least the geometric centre. The central region may include a region adjacent to the centre e.g. with a radii of less than 10% or 20% or 30%. It may also include just the geometric centre, i.e. a point. The central region may refer to a region of the closing member that is separate, e.g. distal, from a peripheral region.

As used herein the term “peripheral region” refers to a region of the closing member that includes the edges. The peripheral region may include a region adjacent to the periphery e.g. with a radii of greater than 90% or 80% or 70%. It may also include just the periphery, i.e. a peripheral edge. The peripheral region may refer to a region of the closing member that is separate, e.g. distal, from the central region.

In embodiments, in the deformed configuration the closing member is arranged to physically contact the code reader (e.g. a reading head thereof). By arranging the code reader to press into the closing member, it may be ensured that the contacted portion of the closing member is aligned with and at a precise distance to the code reader, which may improve reading accuracy. It may also ensure that the central region is more uniform.

In embodiments, a reading head of the code reader is shaped to correspond in shape to a shape of the closing member (e.g. an outer face of the central region) with the container in the deformed configuration. For example, a head of the reader may be flat and/or curved to correspond in shape the closing member with the container in the deformed configuration. A flat or slightly curved head may provide easier reading of the code due to less distortion of the optics. By arranging the reading head to correspond to the closing member, the reading head may be pressed into the closing member or rest on it, which may ensure a more uniform closing member for reading.

In embodiments, the storage portion is hermitically sealed and the positioning mechanism is arranged to reduce an internal volume of the storage portion in the deformed configuration compared to the deformed configuration. By reducing an internal volume a pressure acting on the closing member may be increased, which may provide a more unform surface for reading.

In embodiments, in the deformed configuration the positioning mechanism is arranged to displace the precursor material into the closing member to effect displacement of the closing member when transitioning from the undeformed to the deformed configuration. By moving the precursor material into the closing member a pressure acting on the closing member through the precursor material may be increased, which may provide a more unform surface for reading. However, the force applied to the precursor material may be regulated below a threshold to prevent over compaction of the precursor material that could otherwise be unsatisfactory to process. It will be understood that sufficient precursor material is stored by the storage portion such that as the volume of the storage portion is decreased under deformation an increasing volumes of the precursor material can be pushed into the closing member.

In embodiments, as the container transitions from the undeformed configuration to the deformed configuration, the central region is displaced in the counter depth direction towards the code reader, which may be stationary with respect to the machine. By displacing the container such that the central region of the closing member advances towards the code reader, improved code reading may be achieved.

In embodiments, the positioning mechanism comprises a support to support the container at the flange portion and apply pressing force to a base of the storage portion of the container via a pressing element. It has been found that applying a compressive force in this manner enables suitable deformation of the container to improve reading of the code. The support may for example be integrated as a guide portion.

In embodiments, a shape of (at least part of) the support corresponds in shape to the container in the deformed configuration. By implementing the profile of an abutting portion of the support to have the same, including substantial the same, shape as the container when deformed, the support may suitably guide the container into the deformed portion and efficiently retain it in said position. In particular, if the container is plastically deformed, it may still pass conveniently through the support since at least part of the support is arranged to correspond to the deformed shape.

In embodiments, the machine includes a guide portion, which is arranged to guide the container inserted into the guide portion via gravity from an inserted position to the pre-reading holding position. In embodiments, a guide portion is arranged to guide the container from the holding position via gravity to the processing unit. A gravitationally fed system may be convenient to implement (e.g. the guide portion is vertically aligned or inclined to the vertical). In embodiments, the support is be integrated as a guide portion. In embodiments, the positioning mechanism is arranged to act on the container when in the guide portion, hence at least part of the positioning mechanism is arranged in the guide portion. In embodiments, the guide portion is arranged as an enclosed channel with an entrance for insertion of a container and an exit for transfer of the container to the processing unit with the positioning mechanism located therebetween.

In embodiments, a top engaging portion of the guide portion of the container support corresponds in shape to that of a top surface of the flange in the deformed configuration. In embodiments, a bottom engaging portion of the guide portion of the container support corresponds in shape to that of a bottom surface of the flange in the undeformed configuration. By implementing the guide portion to correspond in shape to the flange portion in both the deformed and undeformed configuration, the container may pass through the guide portion conveniently, with it being able to support both positions.

In embodiments, as the container transitions from the undeformed configuration to the deformed configuration, the whole container is translated in the counter depth direction towards the code reader of the code reading system. By enabling the container to be displaced as well as deformed, it may be more conveniently positioned for reading. Moreover, the container may be more conveniently inserted into the machine since less precision is required.

In embodiments, the code reading system is arranged to read the container before it is processed by the processing unit, and a container gravitationally transferred from the code reading system (e.g. the holding position) to the processing unit. By implement the container to be gravitationally fed from the code reading system to the processing unit, a cost effective loading system may be implemented. Moreover, by implementing the container to be deformed and/or pressed into the reading head the drawbacks of vapour from the container processing system obscuring the code from the code reader may be maximised.

In embodiments, the positioning mechanism is arranged to translate (e.g. to move slideably) along an axis the container and code reader relative to each other from a holding position, in which the container is separated from a reading head of the code reader and the code is aligned along said axis with the code reader, to a reading position, in which the code of the container is in contact with the reading head.

As used herein the term “axis” or “code reading axis” may refer to an axis that the position mechanism translates the capsule along. The axis may be arranged normal to and through a reading direction of the reading head (which is the direction in which code reader obtains an image of the code).

As used herein the term “translate” in respect of the capsule may refer to the capsule being translated in a direction corresponding to the axis. It may include in additional to said translation a minor level of rotation, which for example could occur in the instance the container sits at an angle in the guide portion in the holding position as opposed to aligned to a face of the guide portion that opposes the code reader.

As used herein the term “aligned” in respect of the code and axis may refer to the axis projecting through one or more repetitions of the code such that only an axial distance along the axis (which is typically the depth distance) needs to be closed when transitioning from the holding position to the code reading position. As used herein the term “separated” in respect of the holding position may refer to a geometric distance, e.g. in the depth, direction between the code an code reader.

By implementing the positioning mechanism to translate the container from an aligned out of contact position to an in contact position, a container may be conveniently loaded into the machine and may be accurately read. For example, by implementing an out of contact holding position, the container can be slid into alignment (e.g. via gravity) without interference from the code reader. A simple mechanism may thereafter be implemented to translate the container into contact with the code reader. Direct contact between the code reader and code may enable any debris from the processing unit (e.g. steam or precursor material) that is present on the code and would otherwise interfere with the code reading to be displaced. It may also ensure the code is more uniform when read. Moreover, by having a translating contact, the code reader may be set back from the entry to the processing unit, which may enable the code reader to be located away from debris from the processing unit which may exit via the entry.

In embodiments, the positioning mechanism is configured with in the reading position the closing member to present a comparatively more uniform surface for reading of the code compared to the holding position.

In embodiments, the processing unit includes a container holding portion and a closing portion, which are movable between a container receiving position and a container processing position in a depth direction. The direction of said movement maybe perpendicular (including substantially perpendicular) to the direction of transmission of the guide portion.

In embodiments, the reading head is arranged relative the guide portion to enable a container to travel through the guide portion to the holding position and/or from the holding position to the processing unit without touching the reading head. With such an arrangement the container may slide through the guide portion uninterrupted by the reading head (and only touching the reading head when reading the code in the code reading position, or other loading position). Such an arrangement may reduce sticking of the container in the guide portion.

In embodiments, the positioning mechanism is configured to translate the container with the code reader stationary (e.g. relative the rest of the machine) from the holding position to the reading position. By implementing the container to be displaced to the code reader the code reader can be fixed in a position not to interfere with the transmission of the container through the guide portion, with the container displaced to the code reader when in the guide portion.

In embodiments, the container is translated via a pressing force applied to a base of the storage portion of the container via a pressing element, which is independently actuatable from the guide portion. By having the pressing element actuating through the guide portion, the guide can remain stationary when the container is translated/deformed.

In embodiments, with a flange portion that interconnects the storage portion and the closing member of the container, the guide portion of the machine is arranged to guide the flange portion. The guide portion may comprise a front face engaging portion to engage a front face of the flange (including the portion of the closing member that may overlap the flange portion) and a rear face engaging portion to engage a rear face of the flange, the front face engaging portion and rear face engaging portion separated by a gap greater than a thickness of the flange, such that: the container can pass through the guide portion from the inserted position to the holding position and into the processing unit and; translate from the holding position to the reading position.

By configuring the guide portion to accommodate the translation distance along said code reading axis, the container may conveniently remain in the guide portion whilst translated, which may enable it to be conveniently guided through the machine.

In embodiments, in the reading position the front face engaging portion is in abutment with the front face of the flange portion, and the rear face engaging portion is separated from the rear face of the flange portion. With such an arrangement the front face engaging portion generally pressed into full abutment with the front face of the flange portion such that all parts of said front face touch the flange portion. With the front face portion in full abutment with the front face of the flange, the code may be stably read.

In embodiments, in the holding position the front face engaging portion is at least partially separated from the front face of the flange portion. With such an arrangement, since the guide portion accommodates the flange loosely, in the holding position the container may occupy a range of positions (e.g. depending on how it falls though the guide portion).

In embodiments, the guide portion remains stationary relative to the code reader as the container is moved between the holding position and the reading position. By implement the guide portion to remain in a fixed position relative the code reader it may support the container in both positions whilst being operable to convey the container through the machine.

In embodiments, the positioning mechanism is configured to return the container from the reading position to the holding position (which may be the same holding position as before the code was read or an equivalent holding position) from which the guide portion is arranged to transfer via gravity the container to the processing unit. By returning the read container to the holding position, in which it is separated from the code reader, the container may then pass uninhibited into the processing unit.

In embodiments, the positioning mechanism includes a holding member, which is arrangeable in a closed position to retain the capsule in the holding position and is arrangeable in a transfer position to enable transfer of the capsule to the processing unit. By implement a holding member with said positions an inserted container may be initially retained in the holding position for subsequent reading before being transmitted to the processing unit.

In embodiments, the holding member and pressing element are connected together so that they are dependently actuatable. By joining the holding member and pressing element together, a common actuator may be implemented to actuate both, rather than separate actuation systems.

In embodiments, the closing member is flexible membrane and is arranged to deform to correspond in shape to a reading head of the code reader in the reading position. By arranging the portion of the closing member than includes the code to deform around the reading head, it may be ensured that the code is uniformly presented to the code reader, which may ensure better reading of the code. Moreover, it may enable any debris from the processing unit (e.g. steam or precursor material) that is present on the code and would otherwise interfere with the code reading to be displaced.

In embodiments, the code is arranged on a central region of the closing member. By implementing the code in the central region, it may be ensured that the code is on the most flexible part of the closing member, which may improve reading accuracy by enhancing the aforementioned effects.

In embodiments, the central region of the closing member is arranged to displace by 2-6 mm when subject to a pressing force of 15-120 N or 40-70 N by the reading head. It has been found that such a displacement range when subject to said force presents a uniform reading surface absent of debris.

In embodiments, the positioning mechanism is configured to apply a loading condition to the container, and the code reading system includes a detection system to detect a reading position if a predetermined condition for reading the code is met, and if said condition is met, then the electrical circuitry configured to process/read the code to extract the preparation information in the reading position.

By implementing a detection system to determine if a predetermined condition is met for which the code is arranged in a reading position in which it is suitably positioned for extraction, it can be ensured that reading only occurs when accurate extraction of the information is possible. Such an implementation may for example, avoid the extraction of erroneous preparation information that would implement incorrect control of the processing unit.

As used herein the term “detect” may refer to electrical circuitry of the detection system repetitively or continuously monitoring a variable during a loading condition to and determine if a threshold has been crossed. The detection of the detection system may be triggered by initiation of the loading condition.

As used herein the term “loading condition” may refer to the application of load (e.g. a force and/or a displacement) to the container (e.g. to one or more of the storage portion, flange portion and closing member) to effect a deformation and/or translation of the container. The loading condition may not be applied in the holding position. The application of the loading condition may designate an initiation of the loading position, for which the load can be increased and/or decreased. The loading condition may refer to a load cycle, which may comprise a combination of a load increasing phase and optionally a load decreasing phase. The load increasing phase, may comprises the increasing of the load until the predetermined condition for reading the code is met or a threshold maximum load of the positioning mechanism is exceeded. The load may be increased with various loading profiles, including linear, curved or stepped or combinations thereof. The load decreasing phase may comprise decreasing the load to return the container to the holding position.

As used the term “suitably positioned for extraction” may refer to an arrangement between the code and the code reader such that the preparation information can be fully and/or accurately (e.g. without read errors) extracted. It may also obviate computationally intensive error correction programs to correct read errors.

As used herein the term “extract” in respect of the preparation information may refer to the reading of a data portion of the code to decode the preparation information it stores. Extraction may be part of a code reading process. However, a code may be read, e.g. to identify parts of the code without extraction, e.g. the code may be arranged with sufficient accuracy to enable its location and location of portions forming the code (e.g. including a finder portion and a data portion) however the code may not be arranged for subsequent accurate/full extraction of the preparation information.

In embodiments, a loading condition is applied to transfer the container from the holding position to the reading position. A loading position may be defined as any position in which the loading condition is applied, it may therefore include the reading position.

In embodiments, the loading condition is variable (e.g. the condition may comprise applying a varying force and/or displacement to a container) to selectively deform the body portion of the container. By implementing a variable loading condition, a wide range of different containers may be processed to a reading position. For example, a displacement and/or force history can be adapted to the particular container. The positioning mechanism may automatically adjust the variable loading condition to the container.

In embodiments, the loading condition is variable based on a geometric dimension of the container. The geometric dimension may be the depth e.g., of the body portion from the closing member. The depth may designate large, medium and small sized containers, hence by adapting the loading condition to depth, different sized beverages and/or food stuffs may be provided by the machine. For example, for containers with less depth the same force may be applied as for those with a greater depth, but over a shorter displacement range.

In embodiments, the loading condition is variable based on a stiffness of the container. By adapting the loading condition to stiffness, different container materials may be processed.

In embodiments, the predetermined condition for reading the code comprises a first condition and optionally a different second condition being met. By implementing a first and second condition, multiple conditions can be accounted for to provide increased accuracy.

In embodiments, the first condition is based on a force applied to the container by the positioning mechanism having crossed a threshold or being at a target force threshold. By implementing a force threshold, it may be ensured that the precursor material is not over compacted.

As used herein the term “based on a force applied to the container” may refer to actual measurement of force, e.g. via a loadcell, or via a quantity representative of force.

In embodiments, the force applied is based on an electrical current applied to a drive system for the positioning mechanism. By basing the force on the electrical current applied to the drive system (including any electrical quantity related thereto or derived therefrom e.g. electrical power) a convenient measurement of force may be provided without a dedicated sensor.

In embodiments, the second condition is based on a displacement applied to the container by the positioning mechanism having crossed a threshold. By implementing a displacement related threshold it may be ensured that the container is not over deformed. Such an implementation may be advantageous for highly flexible or containers that are comparatively short in the depth direction, since these deform substantially under low force hence the force threshold is unlikely to be crossed but the displacement threshold is more appropriate.

As used herein the term “based on a displacement applied to the container” may refer to any displacement related quantity, it can include actual displacement or a first or second order derivative (a derivative) of the displacement. In an embodiment, the first order derivative reducing to below a threshold is implemented. By implementing the first order derivative of the displacement, the threshold may be crossed when there is minimal further change in displacement for a given time and an initial large displacement for a given time is passed. Such an implementation allows the same condition for different depth containers to be considered, were having a pre-set displacement amount would not be applicable.

In embodiments, the predetermined condition determined from a digital image of the code. Such an arrangement may obviate the need for a complicated dedicated detection system.

In embodiments, the electrical circuitry implements a smoothing system to reduce fluctuations in the determined force and/or displacement applied. By implementing a smoothing system (e.g. as signal processing) unrepresentative fluctuations in the determined force or displacement applied may prevent the displacement or force thresholds from being erroneously triggered.

In embodiments, the positioning mechanism is arranged to apply said loading condition as increasing in magnitude (e.g. as the load increasing phase of the load cycle) and the detection system is arranged to determine said predetermined condition during the application of the increasing in magnitude load condition. By progressively increasing the force and/or displacement applied to the container, and repetitively deterring if said predetermined condition is met, said quantities may be increased until one of the associated thresholds is crossed.

In embodiments, the electrical circuitry is configured to maintain a load condition as the same (including substantially the same) as when the predetermined condition is met and to read the code with the container subject said maintained load condition. By maintaining the container at the predetermined condition whilst it is read, accurate reading of the code may be provided.

In embodiments, the electrical circuitry is configured to control the positioning mechanism to reapply the variable loading condition if the predetermined condition for reading the code is not met. In embodiments, the electrical circuitry is configured to control the positioning mechanism to reapply the loading condition if it is determined when processing the code (e.g. with code processing circuitry) that it can not be read. By effecting moving the container from the reading position at least partially to the undeformed configuration and/or holding position (e.g. as the load decreasing phase of the load cycle subsequent to the load increasing phase) and then returning it to the reading position, reading accuracy may be improved.

In embodiments, the code reading system includes a code reader to obtain a digital image of the code, and the code reading system includes electrical circuitry to determine from the digital image of the code if the container is in a reading position based on a predetermined condition (e.g. of the digital image of the code), and if said condition is met, then the electrical circuitry configured to process/read the code to extract the preparation information in the reading position.

By basing the predetermined condition to determine if the code is suitably spatially positioned for reading on one or more features in the digital image of the code, other more complex means (e.g. mechanical sensors or actuators) for determining if the code is suitably positioned may be obviated. Moreover, unnecessary processing of the code to extract the preparation information is obviated for a code that is not suitably positioned.

In embodiments, the predetermined condition may be determined from the digital image of the code by a distinct, separate process that is not part of processing the code to extract the preparation information.

In embodiments the predetermined condition is based on a geometric property of the code. As used herein the term “geometric property” in respect of the code may refer to a dimension, angle, or other property defined by one or more units that form the code and/or a surround that the code is arranged on. By using a geometric property it may be determined if the code is suitably arranged as a first step which if passed the more computationally intensive step process for extracting the preparation information is executed, hence the suitability of the code's arrangement may be determined with minimal additional processing.

It will be understood that since the code reader implements a fixed lens and image sensor position, the geometric property is related to the distance of the code away from the code reader, hence if the code is too far away more deformation of the container may be required to enable reliable code reading.

In embodiments, the geometric property is based on a size of one or more units forming the code crossing a threshold size. In embodiments, the geometric property is based on a number of units forming the code arranged within a predetermined area crossing a threshold. In embodiments, the geometric property is based a geometric pattern of the code, e.g. that of a finder portion of the code. In embodiments, the code is formed of units which are 50-200 μm, and are arranged within an area of 600-1600 μm.

In embodiments, the determination if a predetermined condition for reading the code is met is based on an optical property of the code of units forming the code, e.g. the units and/or surround of the code. By using an optical property it may be determined if the code is suitably arranged prior to any processing of the code, hence unnecessary processing steps of the code are obviated. In particular, a luminance of the surround may be determined. Since the code reader incorporates a light source for reading, for a light coloured surround and comparatively dark coloured code units, an observed luminance of the surround may approach that of the code units the further away the code is from the code reader, hence a condition of contact or close proximity of the code to the code reader may be determined when the surround appears comparatively light in colour.

As used herein the term “optical property” may refer to features of light reflected or emitted from or passing through the code and/or surround, it may include a luminance (e.g. within a given solid angle) absorbance or other optical property.

In embodiments, the code reading system includes a positioning mechanism to apply a loading condition to transfer the container the reading position, and the digital image is obtained in the reading position. In embodiments, the positioning mechanism is arranged to apply said loading condition as a increasing in magnitude and the detection system is arranged to determine said predetermined condition during the application of the increasing in magnitude load condition. By repetitively determining whether the predetermined condition is met as the load condition is increased, loading may be paused when said condition is met without applying too much load to the container. In embodiments, the electrical circuitry is configured to maintain the load condition as the same as when the predetermined condition is met and to read the code with the container subject said maintained load condition. In embodiments, the electrical circuitry is configured to control the positioning mechanism to reposition the container in the reading position if the predetermined condition for reading the code is not met and/or it is determined when processing the code that it can not be read.

The present disclosure provides a machine for preparing a beverage and/or foodstuff from a container, the machine comprising: a code reading system to read a code of the container; a processing unit for processing precursor material of the container, and; electrical circuitry to control the processing unit based on preparation information read from the code, wherein the code reading system includes a code reader, and a positioning mechanism. In embodiments, the code is read from a central region of a closing member of a container.

In embodiments, the positioning mechanism is arranged to deform a body portion of the container from an undeformed configuration to a deformed configuration, wherein the positioning mechanism adapted to deform the body portion in the deformed configuration to effect subsequent deformation of the closing member so that it presents a comparatively more uniform surface for reading the code.

In embodiments, the positioning mechanism is arranged to translate along an axis the container and code reader relative to each other from a holding position, in which the container is separated from a reading head of the code reader and the code is aligned along said axis with the code reader, to a reading position, in which the code of the container is in contact with the reading head.

In embodiments, the code reading system includes a positioning mechanism to apply a loading condition to the container, and the code reading system includes a detection system to detect, a reading position, if a predetermined condition for reading the code is met, and if said condition is met, which is based on a force and/or displacement applied to the container, then the electrical circuitry configured to process/read the code to extract the preparation information in the reading position.

In embodiments, the code reading system including a code reader to obtain a digital image of the code, and the code reading system includes a electrical circuitry to determine from the digital image of the code if the container is in a reading position based on a predetermined condition, and if said condition is met, then the electrical circuitry configured to process the code to extract the preparation information in the reading position.

The present disclosure provides a container, which may be for use with the machine of any preceding embodiment or another embodiment disclosed herein, wherein the container comprises: a body portion with a storage portion comprising a cavity that extends in a depth direction for containing a precursor material and with a flange portion connecting the storage portion and closing member; a closing member to close the storage portion, and; a machine-readable code storing preparation information, said code may be arranged on a central region of the closing member, wherein the container is deformable by the machine from an undeformed configuration to a deformed configuration in which the code is readable by the code reader, wherein in the deformed configuration the central region of the closing member is displaced in a counter depth direction by 2-6 mm (e.g. in the reading position relative an unloaded holding position) when the container is subject to a three point bending in a lateral direction, which comprises: supporting the container at left and right sides of the flange portion and applying a force between said left and right sides of the container in the counter depth direction at a base of the storage portion of 15-120 N.

It has been found that such a force range and displacement is sufficient to remove any wrinkles or creases or other discontinuities from the closing member, which may improve code reading accuracy without over compaction of the precursor material.

In embodiments, the central region of the closing member is arranged to displace by 2-6 mm when subject to a pressing force of 15-120 N by the reading head of the code reader. It has been found that such a displacement range when subject to said force presents a uniform reading surface absent of debris.

In embodiments, the closing member is arranged as a flexible membrane. The membrane may be arranged as a laminate of multiple layers. The laminate may include a layer of a paper based material and a polymer based material.

In embodiments, the material of the closing member has a total (e.g. a combined thickness of all layers) thickness of 0.15 mm±10, 20 or 30%. It has been found that such a thickness range provides adequate structural support, whilst remaining conveniently penetrable by an injector or perforable by the machine.

In embodiments, the material of the body portion has a total (e.g. a combined thickness of all layers) thickness of 0.2 mm±10, 20, 30% or 40%. It has been found that such a thickness range provides adequate structural support, whilst remaining conveniently penetrable by an injector. In embodiments, the storage portion is cylindrical with a diameter of 4 cm-7 cm and/or a depth of 5 mm-25 mm.

In embodiments, the system comprises a plurality of containers with a storage portion of different depth, the positioning mechanism configured to transfer said containers from the holding position to the reading position and to read the code of each container.

The present disclosure provides use of the container of any preceding embodiment or another embodiment disclosed herein for a machine for preparing a beverage and/or foodstuff.

The present disclosure provides a method of reading a code of a container for containing a precursor material for preparing a beverage and/or foodstuff. The method may be implemented as part of a process for preparing a beverage and/or foodstuff.

In embodiments, the method comprises: deforming a body portion of the container to effect subsequent deformation of a closing member of the container, and; reading a code from the closing member.

In embodiments, the method comprises translating the container relative a code reader from a holding position in which the container is separated from the code reader and the code is aligned with the code reader, to a reading position in which the code of the container is in contact with the code reader, and; reading the code.

In embodiments, the method comprises: applying a loading condition to the container; determining a reading position if a predetermined condition for reading the code is met, and if met; processing the code to extract the preparation information in the reading position.

In embodiments, the method comprises: obtaining a digital image of the code; determining if a predetermined condition for reading the code is met from the digital image of the code, and if met; reading/processing the code to extract the preparation information.

The present disclosure provides electrical circuitry to implement the method of the preceding embodiment, or another embodiment disclosed herein.

The present disclosure provides a computer readable medium comprising program code to implement the method of the preceding embodiment, or another embodiment disclosed herein.

The present disclosure provides a kit of parts comprising the machine of any preceding embodiment or another embodiment disclosed herein and a plurality of containers of any preceding embodiment or another embodiment disclosed herein, wherein the containers have storage portions with different depths and are suitable for use with said machine.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff.

FIG. 2 is a block system diagram showing an embodiment machine of the system of FIG. 1.

FIG. 3 is an illustrative diagram showing an embodiment fluid conditioning system of the machine of FIG. 2.

FIGS. 4 and 5 are illustrative diagrams showing an embodiment container processing system of the machine of FIG. 2 on open and closed positions.

FIG. 6 is a block diagram showing embodiment control electrical circuitry of the machine of FIG. 2.

FIG. 7 is an illustrative diagram showing an embodiment container of the system of FIG. 1.

FIG. 8 is flow diagram showing an embodiment preparation process, which is performed by the system of FIG. 1.

FIG. 9 is a plan view showing an embodiment code of the containers of the system of FIG. 1.

FIGS. 10 and 11 are flow diagrams showing embodiment processes for extracting preparation information from the code of FIG. 9.

FIGS. 12 to 14 are plan views showing an embodiment code reading system of the system of FIG. 1.

FIGS. 15 and 16 are illustrative diagrams showing the code reading system of FIGS. 12-14.

FIGS. 17 and 18 are plan views showing an embodiment code reading system of the system of FIG. 1.

FIG. 19 is a flow diagram showing an embodiment process for extracting preparation information from the code of FIG. 9.

FIG. 20 is a graphical plot showing force and displacement applied to a container of the system of FIG. 1.

FIGS. 21 to 23 are plan views showing codes of FIG. 9 and a predetermined condition determined therefrom.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. For convenience, a machine that prepares a beverage and/or foodstuff can also refer to the preparation of a precursor for a beverage and/or foodstuff prepared from a pre-precursor material. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical; packet; other like form. The container may be formed from various materials, such as metal or plastic or a combination thereof. The material may be selected such that it is: food-safe; it can withstand the pressure and/or temperature of a preparation process, and; it is biodegradable. The container may be defined as a capsule, wherein a capsule may have an internal volume of 20-100 ml. The capsule includes a coffee capsule, e.g. a Nespresso® or Nescafé® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid (e.g. a solid suspended in a liquid); a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to to change a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to a storage medium that encodes preparation information. The code may be an optically readable code, e.g. a bar code. The code may be arranged as a bit code (e.g. a binary sequence of 0s and 1s encoded by the absence or presence of an element). The code may be formed of a plurality of units, which can be referred to as elements or markers. The elements may implement a finder portion and a data portion, wherein the finder portion encodes a predefined reserved string of bits that is identifiable when processing the code from the data portion, to enable location of the data portion, which encodes the preparation information. The code may be arranged as a one dimensional code, which is read by relative movement between the code and a code reader. The code reader may provide a bit stream signal or a high and low signal for processing by preparation information extraction. The code may be arranged as a two dimensional code, which is processed via a digital image obtained from a camera of the code reader. It will be understood that a code may therefore exclude a mere surface finish or branding on a container, which is not configured in any way for information storage.

As used herein the term “preparation information” may refer to one of more of: parameters as defined herein; a recipe as defined herein; an identifier, and; other information related to the operation of the machine.

As used herein, the term “parameter” may refer to a variable that is used as an input for controlling (e.g. RPM) and/or or a property of the beverage/foodstuff or a precursor thereof that is controlled by the processing unit (e.g. a fluid target temperature or volume) during the preparation process. Depending on the implementation of the processing unit said parameter may vary. Examples include: volume of a particular component of the beverage and/or foodstuff; fluid temperature; fluid flow rate; operational parameters of the processing unit, e.g. RPM of an extraction unit based on centrifugation or closing force for a hydraulic brewing unit; an order of dispensing of components of the beverage and/or foodstuff; agitation (e.g. frothing degree); any of the aforesaid defined for one or more phases, wherein the preparation process is composed of a series of sequential, discrete phases. The parameter may have a value, which may be numerical and can vary in predetermined increments between predetermined limits, e.g. a temperature of the water may vary between 60-90 degrees in 5 degree increments.

As used herein, the term “recipe” or “control data set” may refer to a combination of said parameters, e.g. as a full or partial set of inputs, that are used by the processing unit to prepare a particular beverage and/or food stuff.

As used herein, the term “preparation process” may refer to a process to prepare a beverage or foodstuff from a precursor material or to prepare a pre-precursor material from precursor material. A preparation process may refer to the processes electrical circuitry executes to control the processing unit to process said precursor or pre-precursor material.

As used herein, the term “code reading process” may refer to the process of reading the code to extract the preparation information (which can include the identifier and/or parameters). The process may include one or more of the following steps: obtaining a digital image of the code or a code signal; extracting a sequence of bits from the code; identifying a finder portion of the code in the sequence; locating a data portion using the finder portion, and; extracting the preparation information from the data portion.

### General System Description

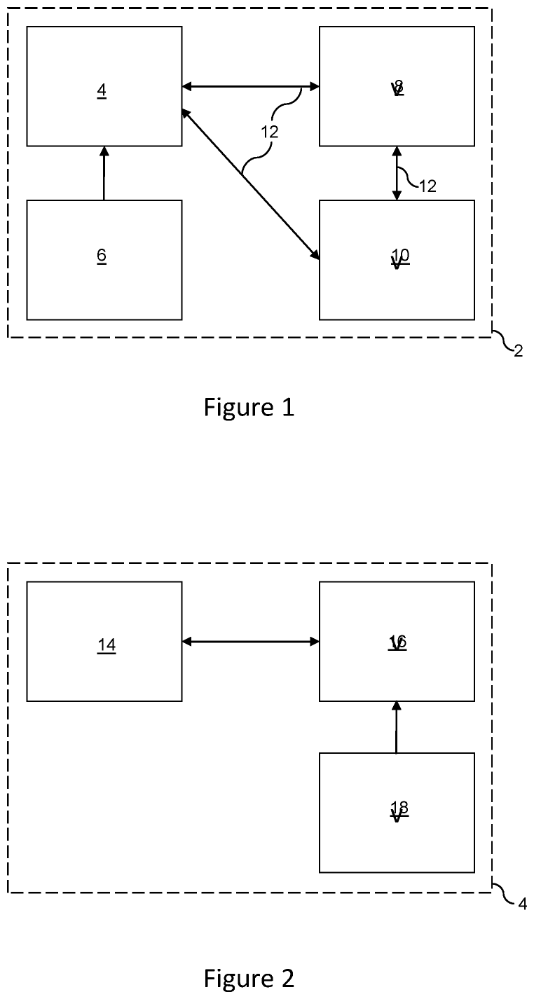

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### Machine

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### First Example of Processing Unit

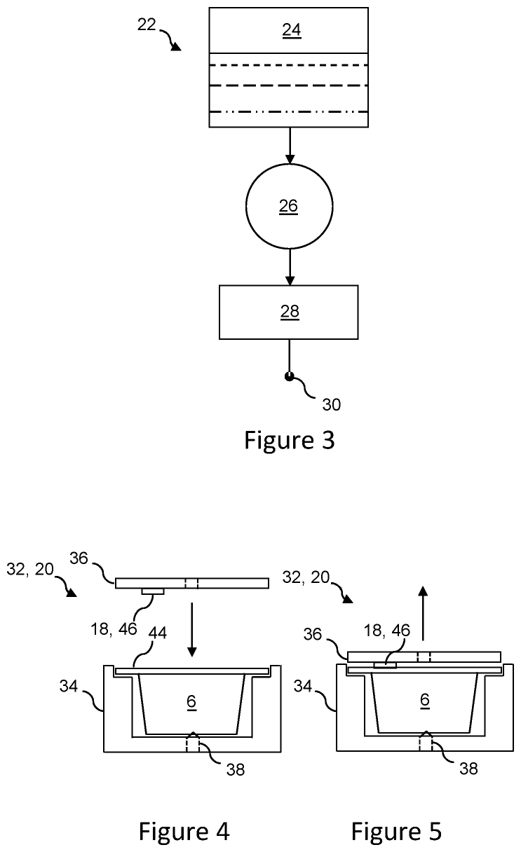

Referring to FIGS. 3, 4 and 5, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### Fluid Conditioning System

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump; the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### Container Processing Unit

The container processing unit 20 can be implemented with a range of configurations, as illustrated in examples 1-6 below. Generally, in examples where the machine 2 comprises a guide portion, in to which a container is inserted and is guided by gravity (e.g. under its own weight) to the container processing unit 20, the container processing unit 20 is arranged with a container holding portion and a closing portion, which are movable between a container receiving position and a container processing position in a depth direction, which is perpendicular (including substantially perpendicular) to a direction of transmission of the guide portion.

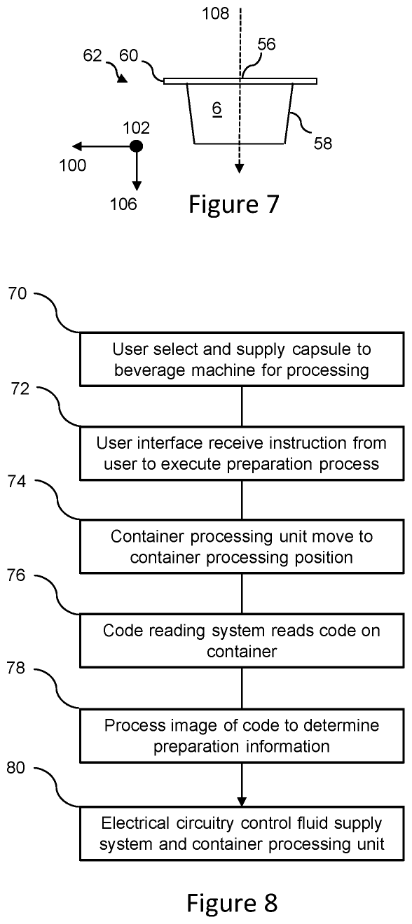

Referring to FIGS. 4 and 5, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4), in which capsule holding portion 34 and a closing portion 36 are arrange to receive a capsule 6 therebetween. The extraction unit 32 is movable to a capsule extraction position (FIG. 5), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 on the capsule holding portion 34 to inject the conditioned fluid into the capsule 6 in the capsule extraction position, typically under high pressure. A beverage outlet 40 on the closing portion 36 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIGS. 4 and 5) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the capsule holding portion and closing portion, they may be alternatively arranged, including: the injection head and beverage outlet are arranged respectively on the closing portion capsule holding portion and; or both on the same portion. Moreover, the extraction unit may include both parts arranged as a capsule holding portion, e.g. for capsules that are symmetrical about the flange, including a Nespresso® Professional capsule. Examples of suitable extraction units are provided in EP 1472156 A1 and in EP 1784344 A1 and provide a hydraulically sealed extraction unit.

In a second example (which is not illustrated) of the container processing unit a similar extraction unit to the first example is provided, however the extraction unit operates at a lower pressure and by centrifugation. An example of a suitable capsule is a Nespresso® Vertuo capsule. A suitable example is provided in EP 2594171 A1. With such an example (or indeed the other examples) a guide portion may be obviated and the container manually loaded into the extraction unit.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a storage portion of the capsule. An example of a suitable capsule is a or Nescafé® Dole Gusto capsule. Examples of suitable extraction units are disclosed in EP 1472156 A1 and in EP 1784344 A1.

In a fourth example, (which is not illustrated) wherein the container is arranged as a packet, the container processing unit implements an extraction unit operable to receive the packet and to inject, at an inlet thereof, fluid from the fluid conditioning system. The injected fluid mixes with precursor material within the packet to at least partially prepare the beverage, which exits the packet via an outlet thereof. An example of such an arrangement is provided in WO2014125123 A1 or in WO2022023578A1.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle. An example of such an arrangement is provided in EP14167344A.

### Code Reading System

Referring to FIGS. 4 and 5, the code reading system 18 is arranged to read a code 44 arranged on a lid of the container 6. The code reading system 18 is integrated with the extraction unit 32 of first example of the container processing unit 20. The code 44 is read with the extraction unit 32 in the capsule extraction position (as shown in FIG. 4).

The code reading system 18 includes a code reader 46 with an image capturing unit and a reading head housing the image capturing unit to capture a digital image of the code 44. Examples of a suitable image capturing unit include a Sonix SN9S102; Snap Sensor S2 imager; an oversampled binary image sensor; other like system.

The electrical circuitry 18 includes image processing circuitry (not illustrated) to identify the code in the digital image and extract preparation information. An example of the image processing circuitry is a Texas Instruments TMS320C5517 processor running a code processing program.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is arranged to read a code at a different location of the container, e.g. on a flange or containment portion. In further variant embodiments, which are not illustrated, the code is a one dimensional code and is read by relative movement between the code reader and the code to produce a code signal.

### Control Electrical Circuitry

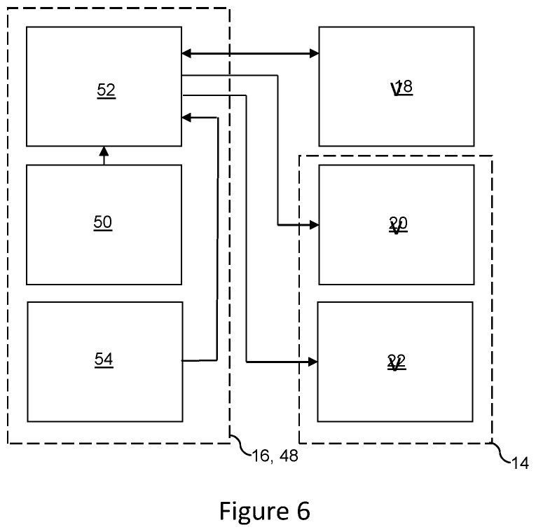

Referring to FIG. 6, the electrical circuitry 16 is implemented as control electrical circuitry 48 to control the processing unit 14 to execute a preparation process. In the embodiment of FIG. 6, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 50 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule.

### Container

Referring to FIG. 7, a first example of a container 6, that is for use with the first example of the processing unit 14 comprises the container 6 arranged as a capsule 6. The capsule 6 includes a closing member 56 and a body portion 62, which comprises a storage portion 58, and a flange portion 60.

The storage portion 58 includes a cavity for storage of the precursor material (not illustrated). The cavity of the storage portion extends in a depth direction 106 from the flange portion 60. Referring to FIGS. 4 and 5, the storage portion 56 is perforated by the injection head 38 to supply conditioned fluid into the capsule.

The storage portion 58 is formed from a paper based material. The storage portion 58 has a thickness of 0.2 mm. The closing member 56 is formed from a paper based material. The closing member 58 has a thickness of 0.15 mm.

As used herein “paper based” may refer to as being formed at least partially from a thin sheet material produced by mechanically or chemically processing cellulose fibres derived from one or more of: wood; rags; grasses, or; other vegetable sources, in water, draining the water through fine mesh leaving the fibre evenly distributed on the surface, followed by pressing and drying.

The closing member 56 closes and may hermitically seal the storage portion 58 and comprises a flexible membrane. Referring to FIGS. 4 and 5, the closing member 56 is perorated to eject the beverage/foodstuff.

The flange portion 60 is formed integrally with the storage portion. The flange portion 60 is arranged at the junction of the storage portion 58 and closing member 56 and comprise a planar extension of the storage portion 58 that is overlapped by a portion of the closing member that is fixed thereto to hermetically seal the precursor material. The flange portion 60 extends in a plane defined by a lateral direction 102 and a longitudinal direction 100. Hence the closing member is planar in said plane.

The capsule 6 is circular cross sections such that it is rotationally symmetric about axis 108. In this way a user can present the capsule to the machine 2 with any orientation about the axis 108. The capsule 6 has a diameter of 53 mm, which is measured across an outer or inner periphery of the flange portion 60 in said plane of the flange portion 60. The capsule 6 can be configured with different sizes, which are characterised by different depths e.g.: 7 mm; 12 mm; 15 mm; 18 mm, and; 21 mm. The capsule 6 in each size is compatible with the first and second examples of the code reading system 18 as will be discussed.

In variant embodiments, which are not illustrated, the closing member may be arranged as convex or concave with respect to the storage portion. For example, for a convex arrangement, a centre of the closing member may extend into the storage portion in the depth direction by up to 1 mm±10% or 20%. A minimum concavity maybe 0.2 mm. For example, for a concave arrangement, a centre of the closing member may extend away from the storage portion in the counter depth direction by up to 4 mm±10% or 20%. A minimum concavity maybe 0.5 mm.

In variant embodiments, which are not illustrated: the body portion comprises the flange portion formed non-integrally with the storage portion and connected thereto; the body portion comprises the flange portion omitted, e.g. the closing member is wrapped around the storage portion; the container may be a non-rotationally symmetric shape, e.g. square sectioned or other shape; the capsule is alternatively dimensioned, including across an outer or inner periphery of the flange portion is 40-70 mm or 53 mm±10% or 20% and the depth is any of the described depths ±10% or 20%; the thickness of the storage portion may have a thickness of 0.1 to 0.4 mm or 0.2±20% or 30%; the thickness of the closing member may have a thickness of 0.05 to 0.3 mm or 0.15±20% or 30%, and; the storage portion and/or closing member may be made out of or include a different material, e.g. including a plastics or aluminium based material.

### Arrangement of Code

Referring to FIG. 7, the code 44 code may be arranged on an exterior surface of the container 6 in any suitable position such that it can be read by the code reading system 18.

In an first example, the code 44 is arranged at a central region of the closing member 56. The code can therefore be read by any code reader that is aligned to the centre of the container. In an second example, the code is reproduced over the entire closing member so that it can be read from any exterior position on the closing member 56. With such an arrangement the closing member does not require any specific alignment with the storage portion, which simplifies cutting and assembly processes for the container 6.

In variant embodiments, which are not illustrated, the code can be arranged on the flange portion 60 (including on either side) and on the storage portion 58. The code may also be arranged on the closing member but not on the central region.

### Process for Preparing Beverage

Referring to FIG. 8, a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first example of the container processing unit 20, the extraction unit 32 is moved from the capsule receiving position (FIG. 4) to the capsule extraction position (FIG. 5)).

Block 76: the electrical circuitry 16 controls the code reading system 18 to provide a digital image of the code 6 of the container.

Block 78: the code processing circuitry of the electrical circuitry 16 processes the digital image to extract the preparation information.

Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion through the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### Code General Description

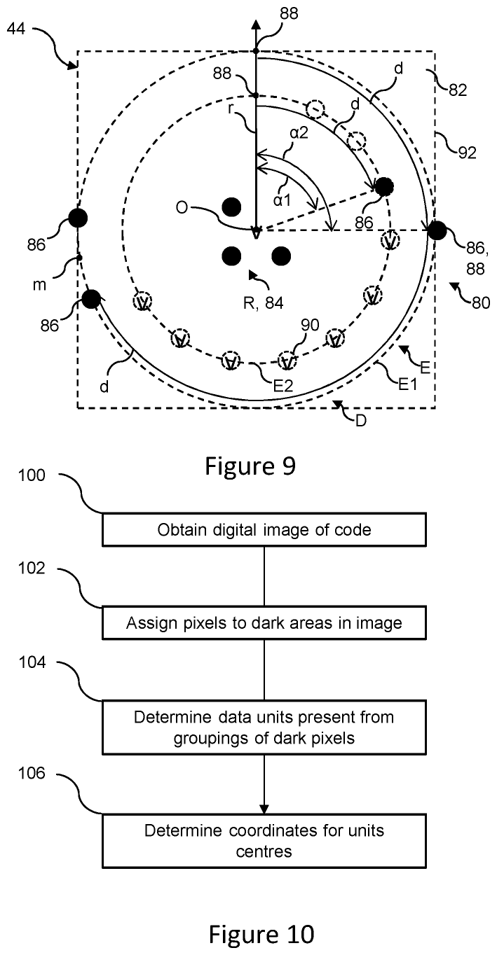

Referring to FIG. 9, the code 44 is formed of a plurality of circular units 80 arranged on a surround 82. The units 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween.

The units 80 are circular in shape. As used herein the term “shape” in respect of the units may refer to an exact shape or an approximation of the actual shape, which can occur to a printing or other manufacturing variations in precision.

In variant embodiments, which are not illustrated: the units are a light colour and the surround is a dark colour; the units have a different shape including one or a combination of the following shapes, triangular, polygon, in particular a quadrilateral such as square or parallelogram; other suitable shape.

The units 80 typically have a unit length of 50-200 μm. As used herein the term “unit length” in respect of a unit 80 may refer to a suitably defined distance of the unit 80, e.g.: for a circular shape the diameter; for a square a side length; for a polygon a distance between opposing or adjacent vertices; for a triangle a hypotenuse. The units 80 are arranged with a precision of about 1 μm.

The units 80 are formed by printing e.g. by means of an ink printer. As an example of printing the ink may be conventional printer ink and the substrate may be: polyethylene terephthalate (PET); aluminium coated with a lacquer (as found on Nespresso Classic capsules) or other suitable substrate.

In variant embodiments, which are not illustrated: the units are alternatively formed, including by embossing, engraving or other suitable means, and; the units are alternatively dimensioned, e.g. a unit length of 80-120 μm.

### Code Generic Organisation

Referring further to FIG. 9, the units 80 are organised into a reference portion R (also referred to as s reference portion) to locate and determine an orientation of the code 44 and a data portion D to store the preparation information.

The units 80 of the code 44, which are arranged as the reference portion R, comprise three reference units 84. The reference units 84 have a unique spatial arrangement in the code 44 to allow the reference portion R to be identified by the electrical circuitry 16 (e.g. with a stored relationship on a memory thereof) in the digital image. The unique spatial arrangement comprises the reference units 84 arrange at three of the vertices of a virtual rectangle (not illustrated), about an origin O at the centre of the rectangle, with specific distances between the reference units 84.

In variant embodiments, which are not illustrated, the reference portion is alternatively implemented, including: as a different arrangement of reference units, e.g. including as a circle or other shape of rectangle; with a different number of reference units, e.g. including as 4 or 5, and; the reference units may have a unique shape that is identifiable from the shape of the other units forming the code.

The arrangement of the reference units 84 enables the definition of a single reference line r at a specific vector relative to said units 84. The reference line r is virtual, and is determined by the electrical circuitry 16 (e.g. with a stored relationship on a memory thereof).

In the particular example, the reference units 84 define, using the right hand rule, a first virtual line (not illustrated) and a second virtual line (not illustrated), wherein: the thumb represents the first virtual line which intersects the centres of two of the refence units 84; the index finger represents the second virtual line which intersects the centres of two of the refence units, one of which being the common to the first virtual line; the second finger is into the plane of the page of the code 44. The reference line r extends from the origin O and is parallel to the first virtual line and is orthogonal to the second virtual line.

In variant embodiments, which are not illustrated, the reference line may be alternatively defined: the may comprise an actual line drawn on the code; it may have an alternative geometric arrangement with respect to the reference units.

Units 80 of the code 44, which are arranged as the data portion D, comprise data units 86. The data units 86 are arranged on an encoding line E that intersects the reference line r. The encoding line E is virtual and is determined by electrical circuitry 16, (e.g. the encoding lines have predefined radii, which are stored on a memory thereof). The centre of the circle of the encoding line E is arranged at the origin O of the reference portion R. The reference line r therefore intersects the encoding line E with a tangent thereto orthogonal to the reference line r. There are two encoding lines E1, E2, each with data units 86.

In variant embodiments, which are not illustrated: other numbers of encoding lines are implemented including 3, 4, or 5; the encoding lines may have non-circular shapes, including rectangular or triangular; the encoding line comprises an actual line drawn on the code.

The encoding line E includes one or more individual data portions, each of which includes a start position 88 and a data unit 86, which is arranged at a distance d along the encoding line E from the start position 88 as a variable to encode a parameter of the preparation information. The start positions 88 are defined virtually and may be determined by electrical circuitry 16 (e.g. the start positions may be stored on a memory thereof).

For the first encoding line E1, the data portion includes two individual data portions: for the first individual data portion the distance d can be any continuous distance from the start position 88 at the reference line r to the first data unit 86 clockwise from the reference line r; for the second individual data portion the distance d can be any continuous distance from the start position 88 at the data unit 86 of the first individual data portion (hence the start position is variable) to the mid-point m between the subsequent two data units 86 in the clockwise direction.

For the second encoding line E2, the data portion includes one individual data portion, for which the distance d can be any one of a plurality of discrete distances, which are illustrated as discrete positions 90 from the start position 88 at the reference line r, with each position associated with a value of the parameter. In the example there are 10 discrete positions 90.

In variant embodiments, which are not illustrated: a start position can be arranged at any position on the encoding line, including spaced away from the reference line; there may be multiple start positions on an encoding line, each with an associated data unit; the start position may be formed as part of the code as a unit rather than defined virtually; an encoding line may comprise combinations of parameters encoded by the continuous distance and the discreet positions; more than one or two data units on the encoding line may define the parameter, which can be determined as an average of the positions, and; the data portion can include any suitable number of individual data portions.

The code 44 includes an outer periphery 92 that the units 80 are arranged within. The outer periphery 92 is rectangular in shape and has a dimension of 600-1600 μm, or about 1100 μm. The code 44 may be repeated such that multiple repetitions of the code 44 are arranged within a single digital image, such that one or several best captured repetitions of the code can be selected for processing.

In variant embodiments, which are not illustrated: the outer periphery may be alternatively shaped, including circular; the outer periphery may have alternative sizes, including greater or smaller than the example range.

In variant embodiments, which are not illustrated, the data portion alternatively encodes the value of said parameter, including as alphanumeric symbols or other arrangement.

Referring to FIG. 10, with reference to the code of FIG. 9, a code processing process, which is executed by the electrical circuitry 16 (or the code processing circuitry thereof) for extraction of the preparation information includes:

### Step 1—Identify Locations of Units of Code

Block 100: obtain digital image of code 44 via the code reading system 118.

Block 102: assign pixels to dark areas in digital image that could represent units 80.

Block 104: if several units in proximity of each other then determine a unit 80 as present.

Block 106: for each determined unit determine a centre of pixel grouping by a rule, e.g. feature extraction, to determine a coordinate of a centre of the unit.

Invariant embodiments, which are not illustrated, alternative processing techniques for determining units and there coordinates may be implemented, including other techniques for locating a centre of a unit or identifying a unit as present, e.g. a level of magnification may be implemented so that a single pixel is determined as a unit, and a centre of a unit may be determined as the centre of a pixel.

### Step 2—Locate Reference Portion and Read Angles of Code

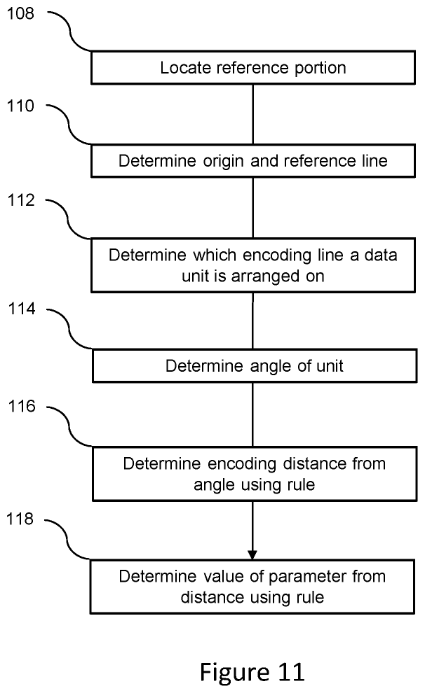

Referring to FIG. 11, with reference to the code of FIG. 9, processing of the code 44 includes:

Block 108: locate reference portion R by searching coordinates of units 80 of code 44 to identify the unique separation and geometric arrangement of reference units 84. This may be implemented by geometric rules including Pythagoras and trigonometry or other suitable rule. Said separation and geometric arrangement can be stored on the electrical circuitry 16 and accessed during searching.

Block 110: for the located reference portion R, define the origin O and the position of reference line r using a stored relationship. The arrangement of the origin and reference line can be stored on the electrical circuitry 16 and mapped onto the coordinates of the located reference portion.

Block 112: for each unit (other than the units of the reference portion) determine based on distance from the origin O which encoding line E the units belong to. The electrical circuitry 16 can store a radii range for each encoding line E and using geometric rules determine the distance of each unit from the origin O and which radii range it falls in.

Block 114: for each unit (other than the units of the reference portion) determine the angle α1, α2 with respect to the reference line r. It is to be noted that the angle is representative of the circumferential distance, and either could be used interchangeably. The angle can be calculated via know geometric relations between the coordinates of the reference line r and a virtual line extending from the origin O and through the associated unit.

### Step 3—Determine Values of Parameters of Preparation Information.

Referring to FIG. 11, with reference to the code of FIG. 9 processing of the code 44 includes:

Block 116: the encoding distance d is determined for each individual data portion. This is achieved by implementing a set of rules for determining the encoding distance d which are stored by the electrical circuitry 16. This can include the one or more of: the number of individual data portions on each encoding line; the start positions 88 of the individual data portions; if a single unit or multiple units represent a data unit 86, and; other suitable relationships.

For example referring to FIG. 9, the rules for determining the encoding distances d of encoding line E1 include that there are: two individual data portions; the start position 88 of the first individual data portion is at the intersection between the reference line r and the encoding line E1; the start position 88 of the second individual data portion is at the data unit 86 of the first individual data portion; the data unit 86 is of the first individual data portion is represented as a single unit of the code 44; the data unit 86 is of the second individual data portion is represented as a two units of the code 44.

For example referring to FIG. 9, the rules for determining the encoding distance d of encoding line E2 include that there is: a single individual data portion; the start position 88 is at the intersection between the reference line r and the encoding line E2; the data unit 86 is of the first individual data portion is represented as a single unit of the code 44.

Block 118: the encoding distances d for each data portion are converted into a value of a parameter. This is achieved by implementing a set of rules for converting the distance of a value which are stored by the electrical circuitry 16.

For example, for encoding line E1: the first individual data portion may encode a water volume of a brewing process wherein the distance d is any continuous value which is linearly related to the water volume, and; the second individual data portion may encode a time of a brewing process wherein the encoding distance d is any continuous value which is exponentially related to the time.

For example, for encoding line E2: the single individual data portion may encode a water temperature of a brewing process wherein the encoding distance d is a discrete value which incrementally changes by 5 degrees C. for each discrete position 90, and the rule specifies which 5 degree increment is closest to the determined encoding distance d.

In variant embodiments, which are not illustrated, other rules can be implemented, including: other mathematical functions relating the encoding distance to the value of the parameter, and; if an encoding distance is the average of the distance several individual data portions, and other suitable relationships.

### First Example of Code Reading System

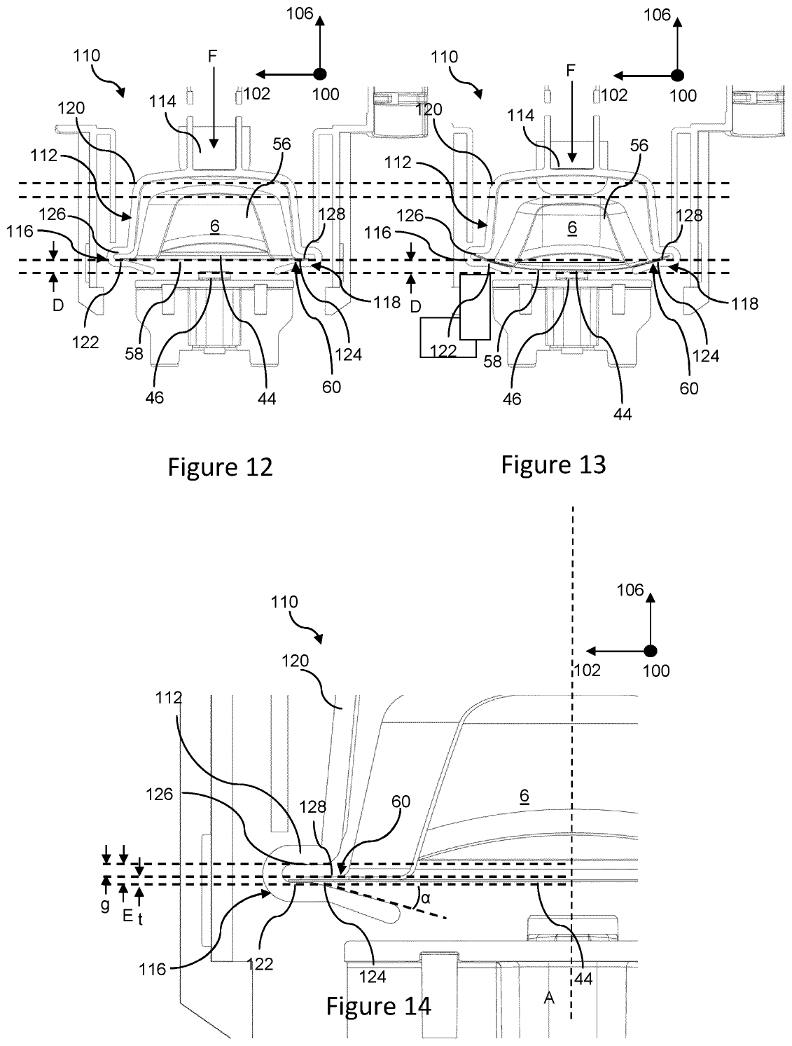

Referring to FIGS. 12 to 14, a first example of the system 2 includes the container 6 and the code reading system 18. The container 6 is as discussed in association with the embodiment of FIG. 7, and includes the code 44 arranged as multiple repetitions over a central portion (not illustrated) of the closing member 56. The central portion includes a geometric centre which is bisected by the axis of rotation 108, and extends to a peripheral region defined by a radii of less than 10% or 20% or 30% of the total radii of the closing member 56.

Whilst the code 44 is described as being arranged as repetitions over the central portion, this arrangement can include the formation of the code 44 on just the central region or as repetitions over the entire closing member. Formed over the entire closing member can include formed on the central region and the peripheral region (the peripheral region is defined as a region that includes the periphery of the closing member and is adjacent the central region). Forming the code over the entire closing member is advantageous since sheet material forming the closing member can have the code printed over the entire sheet and portions that form the closing member can be cut from anywhere in the sheet, as opposed to requiring a specific alignment of the central portion and periphery. Hence container manufacturing is simplified.

The code reading system 18 of the machine 4 includes a positioning mechanism 110, which is arranged to position the container 6 in a holding position (as shown in FIGS. 12 and 14) and a reading position (as shown in FIG. 13).

In the holding position (FIG. 12) the container 6 is separated from the code reader 46 by a distance D that extends in the depth direction 106. In the holding position it may not be possible to accurately read the code, either based on the configuration of the image capturing unit (e.g. the due to a lens of the camera system being inoperable to focus over such a distance) or due to the arrangement of the container (e.g. the exterior surface of the closing member comprising the code 44 may be non-uniform such that the code 44 cannot be located). The central region that comprises repetitions of the code 44 is aligned in the longitudinal direction 100 and lateral direction 102 to the code reader 46, such that to enable reading only the depth distance D needs to be closed when transitioning from the holding position to the code reading position

In the reading position, the code 44 of the container 6 is readable by the code reader 46. In the first example, the container 6 in the reading position is arranged in a deformed configuration by a particular loading condition of three point bending as will be discussed.

The positioning mechanism 110 is arranged to apply a mechanical force to deform the container 6 from an undeformed configuration (in the holding position) to a deformed configuration (in the reading position). In the first example, parts of the storage portion 56, closing member 58 and flange portion 60 are all deformed, hence the entire container may be considered to be deformed.

In particular: the central region of the closing member 56 is displaced in the counter depth direction (e.g. relative a suitable reference, which may be relative to its prior position and/or a peripheral edge of the flange portion or other generally stationary point on the container or machine etc) by the distance D such that the central region experiences less curvature than the peripheral region of the closing member; the flange portion 60 is curved at the left and right sides (as will be discussed), and; the storage portion 58 is compressed in the depth direction and curves proximal the left and right side of the flange portion 60.

It will be understood that in the deformed configuration the positioning mechanism 110 applies a specific loading to the body portion 62 of the container 6 (specifically to both the flange portion 60 and storage portion 56) so that through these portions subsequent deformation of the closing member 58 member is achieved so that it presents a comparatively more uniform surface for reading the code 44.

In variant embodiments, which are not illustrated: the container is otherwise deformed in the reading position, e.g. by a purely compressive force without three point bending to push a base of the storage portion into or towards the closing member; the container is otherwise configured, e.g. without a flange portion and the closing member is directly attached to the storage portion, and; the code is arranged elsewhere other than the central region.

By implementing the central region of the closing member 56 to be displaced distance D, the code reader 46, in the holding position can be located away from, rather than directly above, an inlet (not illustrated in FIGS. 12 and 14) to the processing unit 14. In this way vapour from the processing unit 14 condensing on the code reader maybe minimised, which may otherwise interfere with the code reading process.

Referring to FIGS. 12-14, the positioning mechanism 110 includes a guide portion 112 that supports the container 6 at the flange portion 60 and a pressing element 114, which applies a pressing force F in the counter depth direction 106 to a base of the storage portion 56 of the container 6 to implement the condition of three point bending in the lateral direction 102 over the container 6.

The guide portion 112 includes a left side 116 and a right side 118, which are interconnected by an interconnecting portion 120 that extends laterally around the storage portion 58. The guide portion 112 extends in the longitudinal direction 100 as a channel to slideably convey the container 6 to the processing unit 14 (not illustrated in FIGS. 12-14).

In the deformed position, a left side and a right side of the flange portion 60 are supported by the respective left side 116 and right side 118 of the guide portion 112, substantially in the depth direction 106 (as will be discussed), and slideably in the lateral direction 102, such that the support can be idealised as a sliding support.

The pressing element 114 is translatable in the counter depth direction 100 through an aperture in the interconnecting portion 120, to apply said pressing force F.

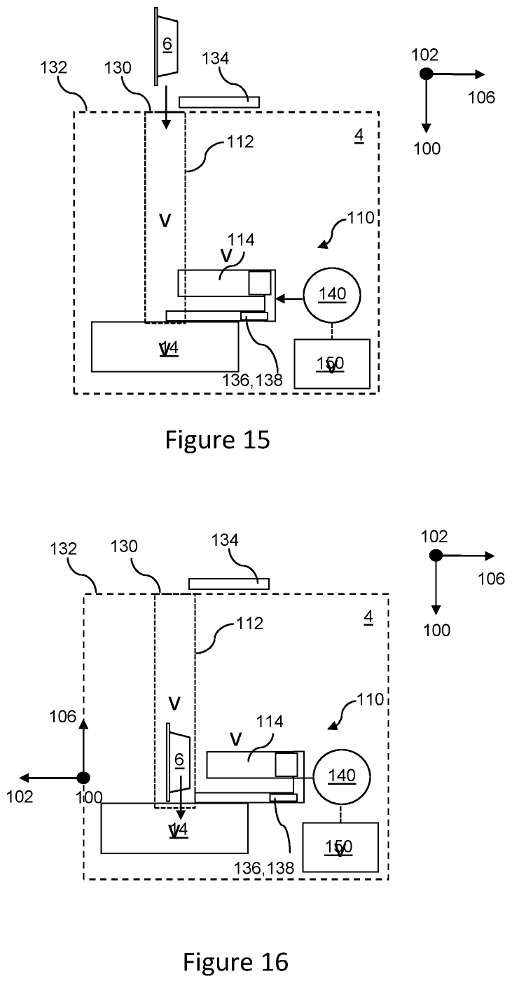

Referring to FIGS. 15 and 16, the pressing element 114 is driven in the depth direction 106 by a drive unit 140 of the positioning system 110, which comprises an electrical motor and drive assembly arranged as a linear actuator. A detection system 150 of the positioning system 110 provides feedback to the electrical circuitry 16 of the position and force applied by the pressing element 114 (and therefore the container 6 being arranged in the holding position or the reading position) as will be discussed.

In variant embodiments, which are not illustrated, the drive system is alternatively implemented including as: a solenoid, and; other linear actuator such as a hydraulic system.

Referring to FIGS. 12-14, the left side 116 and right side 118 of the guide portion 112 have a front surface 122 that engages a front surface 124 of the flange portion 60. The front surface 122 is shaped to correspond to the shape of the container 6 in the deformed configuration (as shown in FIG. 13). In particular, the front surface 122 is angled with increasing distance in the counter depth direction 106 from the periphery of the flange portion 60 towards the centre of the container 6. Referring to FIG. 14, the angle ∝ is 10-30 degrees to the lateral direction 102. In this way, a particular shape in the deformed configuration can be encouraged and better supported. Moreover, the support condition can account for a proportion of the distance D over which the closing member 58 of the container 6 is displaced, hence increasing the possible distance of displacement.

In variant embodiments, which are not illustrated, the front surface is alternatively profiled including: curved, and; aligned to the lateral direction.

The left side 116 and right side 118 of the guide portion 112 have a rear surface 126 that engages a rear surface 128 of the flange portion 60 (the engagement is not shown in the figures). The rear surface 126 is shaped to correspond to the shape of the container 6 in the undeformed configuration (as shown in FIG. 14). In this way if the container returns to the undeformed configuration it can slide to the processing unit 14 via guiding from the rear surface 126 and/or the front surface 124.

In variant embodiments, which are not illustrated: the guide portion is alternatively implemented including: without an interconnection portion; laterally arranged such that it has a conveyor mechanism to transfer the container rather than by gravity, and; the guide portion can also be omitted for examples of container that do not include a flange portion.

Referring to FIG. 14, the front surface 122 and rear surface 126 of the guide portion 112 are separated by a distance E in the depth direction 106, which is defined as the minimum distance in the depth direction 106 between the front surface 122 and the rear surface 126. Since the front surface 122 is angled in the counter depth direction towards the centre of the container 6, the distance E is arranged at the periphery of the flange portion 60 of the container 6. Distance E is greater than the corresponding thickness t of the flange portion 60. In the example, E>1.5 t, and in a particular example E=t+1 to 2 mm.

In this way the container 6 in the undeformed configuration (or deformed configuration) can slide within the guide portion 112 to the processing unit 14 uninhibited.

Moreover, when transitioning from the holding position (FIGS. 12 and 14) to the reading position (FIG. 13) the container 6 can be translated (in addition to the distance achieved by deformation) by distance g, where g=E−t. The translation is along reading axis A, which is normal to and through a reading direction of the reading head of the code reader 46.

It is to be noted that in FIGS. 12 and 14 the container 6 is shown arranged with the front face 124 of the flange portion 60 abutting the front surface 122 of the guide portion. Hence in this example, with such an arrangement the translation distance g would be minimal. However, the container 6 may also be arranged (not illustrated) with the rear face 128 of the flange portion 60 abutting the rear surface 126 of the guide portion 112. Hence the container 6 would be translated the full distance g shown in FIG. 14. Other arrangements (not illustrated) of the container in the guide portion in the holding position are also possible, e.g. the container may be angled between the two abovementioned positions, in which case distance g may be between the two amounts. It will be understood that the particular position of the container in the holding position will be deterred by how it falls though the guide portion.

It will be understood that for the first example of the code reading system 18, the positioning mechanism 110 is arranged to translate along the axis A the container 6 relative the code reader 46 from a holding position, in which the container 6 is separated from a reading head of the code reader 46 and the code 44 is aligned along said axis A with the code reader 46, to a reading position, in which the code 44 of the container 6 is in contact with the reading head.

In this way the container 6 can be kept away from the code reader 46 when sliding through the guide portion 112, which could otherwise cause sticking of the container 6 in the guide portion 112 or after multiple repetitions, damage a reading window (not illustrated) of the code reader 46. Moreover the distance between the code reader 46 and container 6 can be closed to improve reading.

The angled surface 122 also contributes to an amount that the container 6 in effect translates, however this is in combination with deformation of the container 6 as discussed previously.

In variant embodiments, which are not illustrated, the distance E is set to t so that the container can slide through the guide portion without depth translation. With such an arrangement it will be understood that the container is deformed and not translated when transferred from the holding position to the reading position.

In the reading position (FIG. 14) the central region of the closing member 58 of the container 6 is arranged in physical contact with the code reader 46. The closing member 58 is flexible and deforms around a reading head of the code reader 46. The reading head of the code reader 46, which is in direct abutment with the closing member 58, is shaped to correspond to the shape of the closing member 58 with the container 6 in the deformed configuration. In this example, since the central region in the deformed configuration experiences less curvature than the peripheral region and/or the central region when undeformed (typically due to wrinkling) a generally flat shape of the reading head is implemented.

The code reader 46 can be positioned to displace the closing member in the deformed configuration, in the depth direction 106. In this manner there is a pressing force applied to the closing member by the code reader. Alternatively, the code reader 46 can be positioned just to abut the surface of the closing member without displacing it.

In the deformed configuration the central region of the closing member 58 is displaced in a counter depth direction 106 relative the plane of the flange portion 60 prior to its deformation by 2-6 mm when the container is subject to a three point bending in a lateral direction. The three point bending comprises: a sliding support of the container 6 at the left and right edges of the flange portion 60 as discussed herein; a force applied centrally between said left and right edges of the container 6 in the counter depth direction at a base of the storage portion of 15-120 N.

The various capsules, including those as defined previously by variable depth and/or a concave/convex/planar closing member, may all deform by 4 mm in said counter depth direction of the closing member, when subjected to 15-120 N.

As can be observed when comparing FIGS. 12 and 13, the three point bending reduces an internal volume of the storage portion in the deformed configuration compared to the deformed configuration. In this way, since the container 6 is hermitically sealed, an internal pressure acting on the closing member 58 increased, which may provide a more unform surface for reading. Moreover, since in the deformed configuration the depth of the container 6 is reduced, for containers 6 which are sufficiently full, the precursor material can be displaced into the closing member 58. This may also provide a more unform surface for reading.

Referring to FIG. 15, the container 6 is inserted into the machine 24 via an inlet 130 through a housing 132 of the machine 2. The inlet 130 is opened and closed by a user actuated closing member 134 that is actuated between open (as illustrated) and closed (not illustrated) positions. The container 6 is inserted directly into the guide portion 112, which transfers the container 6 in the longitudinal direction 100 via gravity acting on its own mass to the holding position (FIG. 12).

The positioning mechanism 110 includes a transfer mechanism 136, which comprises a holding member 138 and the drive unit 140. The holding member 138 is arrangeable in a closed position (as shown in FIG. 15) to retain the container in the holding position (rather than enabling it to proceed via the guide portion 112 to the processing unit 114), prior to its transfer to the reading position (as shown in FIG. 12). In the closed position, at least part of the guide portion 112 is unblocked by the holding member 138 to prevent said transmission.

A user subsequently inputs via the user interface/input unit 50 an instruction to read the code/prepare a beverage/foodstuff from the container 6 (as discussed at block 72 in FIG. 8) and the positioning mechanism 110 based on said instruction transfers the container 6 to the reading position (FIG. 13), in which the code 44 is read. The holding member 138 is integrated with the pressing element 114 such that it moves with the pressing element 114 and is maintained in the closed position to prevent the container 6 from transferring via the guide portion 112 to the processing unit 114.

Subsequent to successful reading of the code 44 the positioning mechanism 110 then automatically returns the container 6 to the holding position (FIG. 12). The holding member 138 is moved to a transfer position (FIG. 16) to enable the container to proceed via the guide portion 112 to the processing unit 114. In the transfer position, sufficient an amount of the guide portion 112 is open and unblocked by the holding member 138 to permit said transmission.

In variant embodiments, which are not illustrated, the closing member may be actuated by a dedicated drive unit or may be omitted; the transfer mechanism may have a dedicated drive unit, so that it is moved independently of the pressing element.

### Second Example of Code Reading System

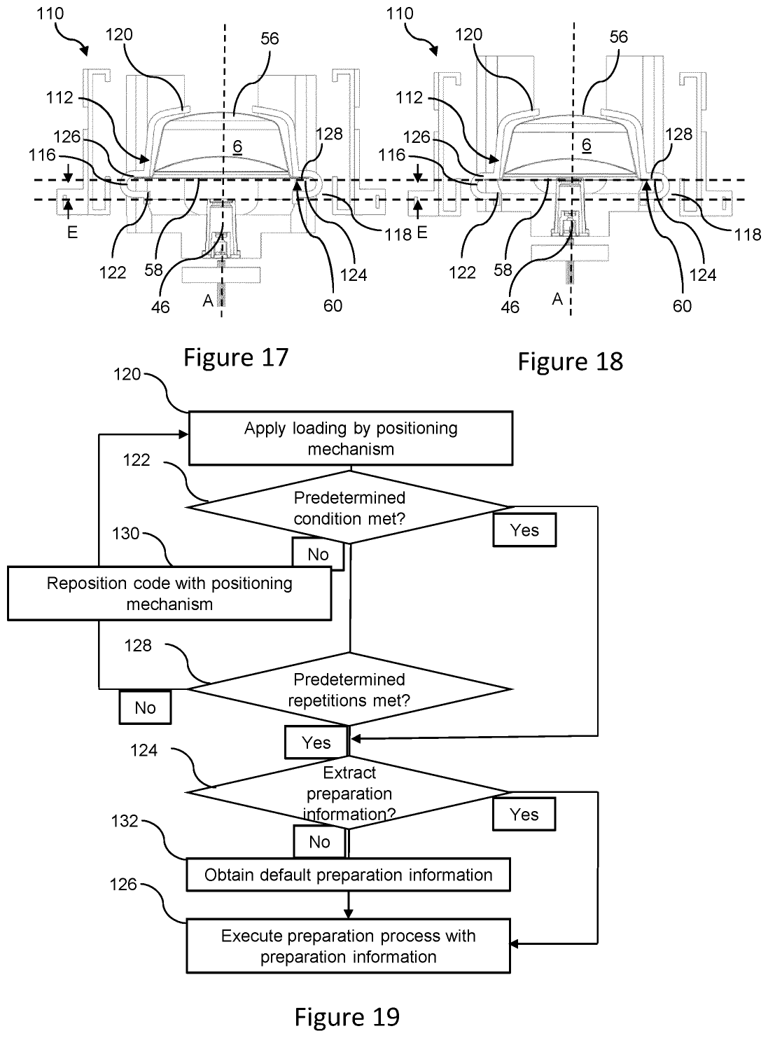

Referring to FIGS. 17 and 18, a second example of the system 2 implements the code reading system 18 of the first example but with a positioning mechanism 110 to implement a different reading position (shown in FIG. 18). Where not discussed, for brevity, the features and variants of the second example are as for the first example.

In the second example, the positioning mechanism 110 is arranged to translate along the reading axis A (in the counter depth direction 106) the container 6 and code reader 46 relative to each other from: a holding position (shown in FIG. 17), in which the container 6 is separated from the reading head of the code reader 46 and the code 44 is aligned along said axis A with the code reader 46, to; a reading position (shown in FIG. 18), in which the code 44 of the container 6 is in contact with the reading head of the code reader 46.

In the reading position, the body portion 62 of the container 6 is generally undeformed (particularly when compared to the first example), however the closing member 58 is deformed and is in contact with the code reader 46 as will be discussed.

The guide portion 112 is arranged with a front surface 122 and rear surface 126 parallel to the lateral direction 102. The front surface 122 and rear surface 126 are separated by a distance E in the depth direction 106. Distance E is greater than the corresponding thickness t of the flange portion 60. In the example, E>1.5 t, and in a particular example E=t+1-5 mm.

Since the storage portion 56 and the flange portion 60 of the container 6 are not substantially deformed in the reading position, the pressing element of the first example can be omitted.

In the second example the guide portion 112 remains stationary relative the machine 2 and the code reader 46 is translated along the axis A to press into the closing member 58. In the reading position (FIG. 18) the code reader 46 presses the rear surface 128 of the flange portion 60 of the container 6 into the rear surface 126 of the guide portion 112.

The closing member 58 is flexible and is arranged to deform to correspond in shape to a reading head of the code reader 46 in the reading position. The code 44 is arranged on the central region of the closing member 58. The central region of the closing member is arranged to displace by 2-6 mm when subject to a pressing force of 15-120 N by the code reader 46.

In variant embodiments, which are not illustrated: the second example is alternatively configured with the code reader to remain stationary and the guide portion to be translated to carry the container to the code reader, or; a pressing element may be implemented as for the first example to translate the container within a stationary guide portion to the a stationary code reader.

### Detection System

Referring to FIGS. 15 and 16, the first or second examples of the code reading system 18 (including the discussed variant embodiments that are associated therewith) include a detection system 150 to detect a reading position FIGS. 13 and 18) if a predetermined condition for reading the code 44 is met, and if said condition is met, then the electrical circuitry 16 configured to process the code 44 to extract the preparation information in the reading position.

Referring to FIG. 19 a process of determining if the predetermined condition for reading the code 44 is met comprises:

Block 120: implementing the positioning mechanism 110 to move the container 6 from the holding position (FIGS. 12, 14 and 17) to a loading position. The loading position may be designated as from the point of initiation of application (or substantial application) of a loading condition by the positioning mechanism 110 to the container 6 to effect its deformation and/or translation for the purpose of reading the code 44.

In the loaded position, the positioning mechanism 110 applies a load increasing phase of a load cycle (examples of which will be discussed) to the container 6, which may comprise the application of a force and/or a displacement to the container 6. Typically, the force is ramped up to a constant value or is ramped up, and a variable displacement is applied.

Block 122: the electrical circuitry 16 uses an input (e.g. as a signal or digital information) from the detection system 150 to determine a reading position (FIGS. 13 and 18) if a predetermined condition for reading the code 44 is met (as will be discussed). At the point of the predetermined condition being met a positive determination under Block 122 is triggered, and Block 124 is executed.

Block 124: the preparation information is read from the code (as previously discussed in association with FIGS. 10 and 11). At Block 124, the electrical circuitry 16 is configured to maintain the load condition as the same (including substantially the same) as when the predetermined condition was met at block 122 so that the code is read under said load condition.

Block 126: if the preparation information is successfully read at Block 124, then the preparation process is executed with control of the preparation unit 14 based on the extracted preparation information.

In the event that a complete load increasing phase of the load cycle is applied (e.g. such that the maximum load/displacement that the positioning mechanism 110 is capable of is applied) and the predetermined condition for reading the code is not met then a negative determination under Block 122 is triggered with Blocks 128 and Blocks 130 subsequently executed.

Block 128: if it is determined that a predetermined number (e.g. 2 or 3) of repetitions of Blocks 120 and 122 have already been executed (e.g. the container 6 has been repositioned multiple times and still the predetermined condition is not met), then Block 124 is executed and the preparation information is attempted to be extracted, else Blocks 120, 122 and 130 are repeated.

Block 130: if the predetermined condition is not determined as being met, then the electrical circuitry 16 is configured to control the positioning mechanism 110 initiate repositioning of the container 6 by transition the container 6 to the holding position. This is initiated by applying a load decreasing phase of the load cycle. Blocks 120 and 122 are then subsequently repeated.

Block 132: if the preparation information is not successful extracted at Block 122, then default preparation information is obtained from an electronic memory (not illustrated) of the system 2. And at Block 124 a preparation process is executed with control of the preparation unit 14 based on the default preparation information.

In variant embodiments, which are not illustrated: at Block 130 as an alternative to transitioning the container to the holding position, remaining in the loading position the load of the load increasing phase may be partially reduced and then increased again at Block 120; if at Block 124 the preparation information cannot be extracted, then an error message may be returned to the user via the user interface; Block 128 may be omitted such that the container 6 is not repositioned if a predetermined condition is not determined, and; at Block 124 if the code 44 can not be read then the Blocks 128 and 130 can be executed in the same manner as was discussed for Block 122. In examples of the position mechanism that do not apply a variable load to the container (e.g. a fixed container reading position is set) then it will be understood that Block 122 may be omitted.

Block 122 includes sub Block 122A and block 122B (not illustrated) which are a first condition, and; a different second condition, wherein both first and second conditions are required to be met as the predetermined condition of Block 120 (hence AND logic).

In variant embodiments, which are not illustrated: there are other numbers of conditions, e.g. only a first condition or an additional third condition etc., and; other logic may be implemented between the conditions e.g. OR such than only one of the conditions requires triggering.

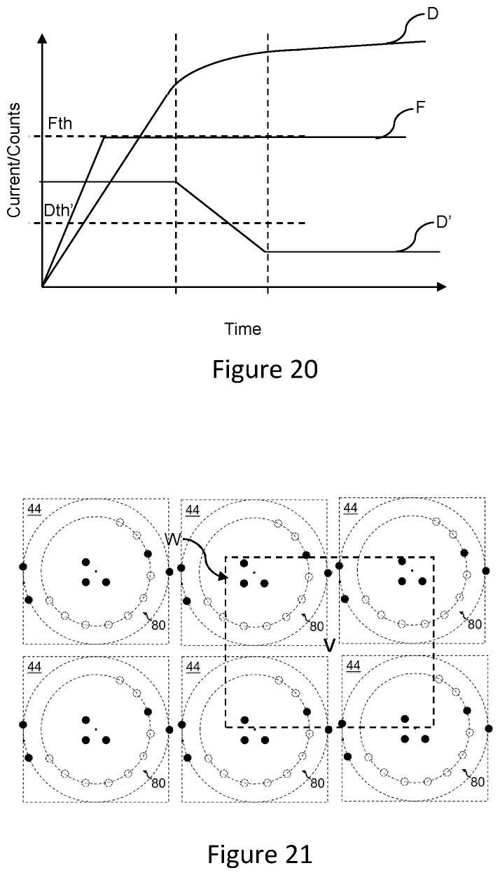

Referring to FIG. 20 a loading phase of a load cycle is shown for a container in a loading position. In the example the displacement and force are initially applied to a container with a linear profile, which varies when subject to increased resistance from the container. The load may be increased with various loading profiles, including linear, curved or stepped or combinations thereof.

The first condition is based on the force F applied to the container by the positioning mechanism being maintained at a target force, i.e. at or below a threshold force Fth. The force F is measured by electrical current applied to the electrical motor of the drive unit 140, which is representative of the applied force.

In variant embodiments, which are not illustrated; the force is alternatively measured e.g. via a load cell; there is no target force and just a threshold force which if exceeded then the predetermined condition is met, and; another electrical quantity (including a derivative thereof) of the drive unit/the associated circuit may be used instead of current that is representative of force such as power (although it is to be understood that since the power is based on current a measure of power is also based on current).

A smoothing system (not illustrated) to reduce fluctuations in the force is implemented. By implementing a smoothing system (e.g. as signal processing or via electrical componentry such as a resistor and capacitor) unrepresentative fluctuations in the force may prevent the force thresholds from being erroneously triggered or may permit easier maintenance of the target force. The smoothing system may also be implemented for the second condition.

The second condition is based on a displacement D applied to the container by the positioning mechanism 110 crossing a threshold. In particular, it is based on a first order time derivative D′ of the displacement applied to the container reducing from an amount to below a threshold Dth.

By considering the rate change of displacement reducing below a threshold, it can be determined when there is relatively little further displacement under a given force, i.e. the container has stopped displacing.

The displacement D is based encoder counts produced from an encoder connected to the drive unit 140, hence the number of encoder counts in a given time gives a first order derivative of the displacement.

In variant embodiments, which are not illustrated; the displacement is alternatively measured e.g. via a displacement sensor; the displacement rather than a first order time derivative thereof is used for the second condition, e.g. the number of counts crossing a threshold may be used; other order derivatives of displacement may also be used.

By implementing both displacement and force criterion, a range of container geometries and flexibilities can be arranged in a deformed configuration/reading position suitable for reading the code:

For containers that are relatively thin in the depth direction are not particularly stiff, the rate change of the displacement provides an accurate estimate of when the container is sufficiently deformed, whereas the electrical current target prevents excessive force being applied, which could otherwise cause compaction of be precursor material rendering not processable.

For containers that are relatively thicker, they may experience a relatively linear displacement rate, compared to the thinner container, such that it can only be determined that there is sufficient displacement once the rate change of displacement begins to decrease below the threshold, and the electrical current target prevents excessive force being applied at any point.

The thresholds can be calibrated based on experimental data, i.e. testing of a range of force and displacement conditions that suitable code reads were provided at.

In variant embodiments, the predetermined condition is based on a digital image of the code as will be discussed or other variables.

It the above example, the loading condition is variable since the first order derivative of displacement threshold (rather than a displacement threshold) is considered when the container is subject to a constant force (the maintaining of the force below or at the threshold force). Consequently, for containers with different depth body portions a different overall displacement is automatically applied, however the first order derivative of displacement threshold can be maintained as the same amount. Hence the loading condition is automatically adapted to different container geometries.

Moreover, for stiffer containers due to different materials and/or different thickness, in a similar manner a different overall displacement is applied, however the first order derivative of displacement threshold can be maintained as the same amount.

In variant embodiments: a fixed displacement and/or force may be applied; a fixed displacement and variable force may be applied; the loading condition can be otherwise adapted.

The processes of FIGS. 19 and 20 can be integrated with the overall process for preparing a beverage shown in FIG. 8, as part of an alternative block 74 (in which the code reading system 18 is separate from the processing unit 14) that alternatively comprises operation of the positioning mechanism 110 to transfer the container from the holding position to the reading position. In variant embodiments, code reading system (including the detection system) is alternatively implemented as part of the processing unit, as for the embodiments discussed in association with FIGS. 4 and 5 such that closing and opening of the processing unit also moves the container from the holding position to the reading position.

### Condition Based on Digital Image of Code

Referring to FIGS. 21-23, the code reading system 118 includes a code reader to obtain a digital image of the code 44, and the code reading system 118 includes electrical circuitry 16 to determine from the digital image of the code if the container is in a reading position based on a predetermined condition, and if said condition is met, then the electrical circuitry configured to process the code to extract the preparation information in the reading position.

The predetermined condition being based on the digital image of the code 44 can be integrated in the previous process as the predetermined condition at Block 122 discussed in association with FIG. 19 or as part of an alternative implementation that does not include a positioning mechanism 118. It will therefore be understood that the disclosure associated with the detection system in reference to FIG. 19 is incorporated in this example, which for brevity is not reiterated.

Referring to FIG. 21, the predetermined condition in an example is based on a geometric property of the code:

In a first example the property is determined based on a diameter of one or more of the units 80 of one or more of the codes 44 of the image being greater than a predetermined amount. Such and example can test if the code 44 is within a suitable distance range of the code reader for reading.

In a second example, the property is determined based on a number of units 80 forming the code 44 arranged within a predetermined sized window W being greater than a predetermined amount. Such an example can test if the code 44 is within a suitable distance range of the code reader for reading.

In a third example (which is not illustrated), the geometric property is based a geometric pattern of the code, e.g. that of the finder portion of the code and a particular angle/distance between reference units of the finder portion, which are at fixed positions with respect to each other. Such an example can test the integrity of the code 44 e.g. if it is distorted due to creases or other discontinuities in the closing member on which it is arranged.

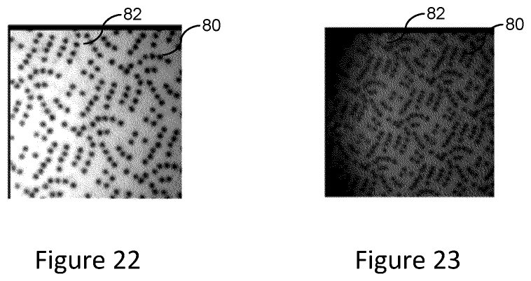

Referring to FIGS. 22 and 23, the predetermined condition in a further example is alternatively based on an optical property of the code:

FIG. 22 illustrates the code 44 arranged contiguous (i.e. touching or in close proximity) to the code reader. It can be observed that the surround 82 is white and the code units 80 are clearly distinguishable as black.

FIG. 23 illustrates the code 44 arranged too far away from the code reader 46 for suitable reading. It can be observed that the surround 82 is partially white and back in some areas and the code units 80 are not clearly distinguishable.

Accordingly the code 44 being arranged in a suitable position can be determined by one of more of the following: a mean grey scale crossing a threshold; a proportion of a particular amount of grey scale crossing a threshold; a mean luminance, and; other related feature.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
4 Machine
14 Processing unit
20 Container processing unit (first example)
32 Extraction unit
34 Capsule holding portion
36 Closing portion
38 Injection head
40 Beverage outlet
22 Fluid conditioning system
24 Reservoir
26 Pump
28 Heat exchanger
30 Outlet
16 Electrical circuitry
48 Control electrical circuitry
18 Code reading system
46 Image capturing unit
130 Inlet
132 Housing
134 Closing member
136 Transfer mechanism
138 Transfer member
110 Positioning mechanism
112 Guide portion
116 Left side
118 Right side
122 Front surface
126 Rear surface
120 Interconnecting portion
114 Pressing element
140 Drive unit
150 Detection system
6 Container
56 Closing member
44 Code
80 Units
R Reference portion
84 Reference units
r Reference line
O Origin
D Data portion
86 Data units
E Encoding line
d Distance
88 Start position
90 Discrete positions
I Code Identifying portion
94 Discrete position
96 Identifying units
82 Surround
92 Outer periphery
62 Body portion
58 Storage portion
60 Flange portion
124 Front surface
128 Rear surface
8 Server system
10 Peripheral device
12 Computer network

1. A system comprising a container and a machine for preparing a beverage and/or foodstuff thereof,
the container including:
a body portion comprising a storage portion for containing a precursor material;
a closing member to close the storage portion; and
a machine-readable code storing preparation information,
the machine including:
a code reading system to read the code of the container;
a processing unit for processing the precursor material of the container; and
electrical circuitry to control the processing unit based on the preparation information read from the code,
wherein the code reading system includes a positioning mechanism to apply a variable loading condition to the container to selectively deform the body portion of the container,
and the code reading system includes a detection system to detect a reading position if a predetermined condition, which is based on a force and/or displacement applied to the container, for reading the code is met,
and if the condition is met, then the electrical circuitry is configured to read the code to extract the preparation information in the reading position.

2. The system of claim 1, wherein the loading condition is variable based on:
a geometric dimension of the container, wherein the geometric dimension is a depth of the body portion from the closing member, and/or
a stiffness of the container.

3. The system of claim 1, wherein the predetermined condition for reading the code comprises a first condition and/or a different second condition being met.

4. The system of claim 3, wherein:
the first condition is based on a force applied to the container by the positioning mechanism being at a target force or having crossed a target force threshold, and/or
the second condition is based on a displacement applied to the container by the positioning mechanism having crossed a threshold.

5. The system of claim 4, wherein:
the force applied is based on an electrical current applied to a drive system for the positioning mechanism, and/or
the displacement is based on a rate change of the displacement decreasing below a threshold.

6. The system of claim 4, wherein the container is configured with a central region of the closing member to displace in a counter depth direction by 2-6 mm in the reading position relative an unloaded holding position when the container is subject to a three point bending in a lateral direction, which comprises:
supporting the container at left and right sides of a flange portion connecting the storage portion and the closing member, and applying a force between the left and right sides of the container in the counter depth direction at a base of the storage portion of 15-120 N,
wherein the central region is a region of the closing member that includes at least the geometric centre and is separate from a peripheral region, which includes the peripheries.

7. The system of claim 1, wherein the positioning mechanism is arranged to apply the loading condition as increasing in magnitude, and the detection system is arranged to determine the predetermined condition during the application of the increasing in the magnitude of the loading condition.

8. The system of claim 7, wherein the electrical circuitry is configured to maintain a load condition as the same as when the predetermined condition is met and to read the code with the container subject the maintained load condition.

9. The system of claim 1, wherein the electrical circuitry is configured to control the positioning mechanism to reapply the variable loading condition if the predetermined condition for reading the code is not met and/or if t code cannot be read in the reading position when processing the code.

10. The system of claim 1, wherein the positioning mechanism is configured, with the container in the reading position, the code of the container is in contact with a code reader of the code reading system and with the container in an unloaded holding position with the code separated from the code reader.

11. A machine for preparing a beverage and/or foodstuff or a precursor thereof, the machine comprising:
a code reading system to read a code from a container;
a processing unit for processing precursor material of the container; and
electrical circuitry to control the processing unit based on preparation information read from the code,
wherein the code reading system includes a positioning mechanism to apply a loading condition to transfer the container from a holding position to a reading position,
wherein the code reading system includes a positioning mechanism to apply a variable loading condition to the container to selectively deform the body portion of the container,
and the code reading system includes a detection system to detect a reading position if a predetermined condition, which is based on a force and/or displacement applied to the container, for reading the code is met,
and if the condition is met, then the electrical circuitry is configured to read the code to extract the preparation information in the reading position.

12. The machine of claim 11, wherein the predetermined condition comprises a first condition based on a force applied by the positioning mechanism to the container having crossed a threshold,
and/or a second condition based on a displacement applied by the positioning mechanism to the container having crossed a threshold.

13. A container, wherein the container comprises:
a body portion comprising a storage portion for containing a precursor material;
a closing member to close the storage portion;
a flange portion connecting the storage portion and closing member; and
a machine-readable code storing preparation information, the code arranged on a central region of the closing member,
wherein the body portion of the container is deformable by a machine from an undeformed configuration to a deformed configuration in which the code is readable by a code reader of the machine,
wherein in the reading position the central region of the closing member is displaced in a counter depth direction by 2-6 mm in the reading position relative an unloaded holding position when the container is subject to a three point bending in a lateral direction, which comprises:
supporting the container at left and right sides of the flange portion and applying a force between the left and right sides of the container in the counter depth direction at a base of the storage portion of 15-120 N, such that the central region experiences less curvature than a peripheral region of the closing member,
wherein the central region is a region of the closing member that includes at least the geometric centre and is separate from a peripheral region, which includes the peripheries.

14. (canceled)

15. A method of reading a code of a container for containing a precursor material for preparing a beverage and/or foodstuff, the method comprising:
applying a variable loading condition to the container to selectively deform a body portion of the container;
determining a reading position if a predetermined condition, which is based on a force and/or displacement applied to the container, for reading the code is met, and if met;
reading the code to extract preparation information in the reading position.
